(19) United States
(12) Patent Application Publication
(10) Pub. No.: US 2015/0177529 A1
(43) Pub. Date: Jun. 25, 2015

(54) THREE-DIMENSIONAL EYEGLASSES

(71) Applicant: SHENZHEN CHINA STAR OPTOELECTRONICS TECHNOLOGY CO., LTD., Shenzhen, Guangdong (CN)

(72) Inventors: Yong Zhao, Shenzhen (CN); Liren Ouyang, Shenzhen (CN); Juan Liu, Shenzhen (CN); Yongji Zhang, Shenzhen (CN)

(21) Appl. No.: 14/240,354

(22) PCT Filed: Jan. 23, 2014
(86) PCT No.: PCT/CN2014/071256

§ 371 Date: Feb. 21, 2014

(30) Foreign Application Priority Data
Dec. 25, 2013 (CN) 201310728940.8

(51) Int. Cl. G02B 27/26; G02B 27/22

(52) U.S. Cl. CPC G02B 27/26; G02B 27/2228; G02B 5/3083

(57) ABSTRACT

The present disclosure proposes a type of three-dimensional eyeglasses, including a polarizer and a first wave plate on one side of the polarizer, the first wave plate is a quarter-wavelength wave plate and includes a first left lens and a first right lens corresponding to the left eye and the right eye of a user respectively, the optical axis of the first left lens is vertical to that of the first right lens, and the angles formed between the direction of the transmission axis of the polarizer and those of the optical axes of the first left lens and the first right lens are both 45 degrees, wherein, a second wave plate is arranged on the side of the polarizer away from the first wave plate, the light from a screen passes through the first wave plate, the polarizer and the second wave plate and is then emitted, and the second wave plate is arranged in such a manner that the light emitted after passing through the three-dimensional eyeglasses is circularly polarized light. This enables the human eyes to feel more comfortable and is less prone to cause fatigue.

### FIELD OF THE INVENTION

The present disclosure relates to the technical field of three-dimensional display, and specifically to a type of three-dimensional eyeglasses.

### BACKGROUND OF THE INVENTION

Human beings determine different distances according to the parallax between the two eyes. Two eyes of a human are spaced by about 5 centimeters. Except for the case of aiming at the right front, the viewing angles of the two eyes are different when the two eyes are fixed on any object. Although the difference is small, when the difference is transferred to the brain through retinas, the brain generates far and near depth with the tiny difference, so as to generate third dimension.

A three-dimensional (3D) movie is produced by using the principle of three-dimensional vision of the two eyes. Two movie cameras, which are arranged in parallel to represent the left and right eyes of human respectively, are utilized to synchronously shoot two movie pictures with slight horizontal parallax therebetween in the same manner as human eyes do when viewing a scene. For displaying, the two movies are installed in left and right movie projectors respectively, and two polarizers, the polarization axes of which together form a 90-degree angle, are installed in front of projection lenses respectively. The two projectors run synchronously and project pictures onto a metal screen at the same time to form double images, i.e. the left image and the right image. An audience wears a pair of special polarized eyeglasses. Because the polarization axes of the left and right polarizers on the eyeglasses are vertical to each other and are parallel with those in front of the projection lenses in each case, the left eye of the audience can only see left images, and the right eye can only see right images. The left and right images are superposed on the retinas with the convergence function of the two eyes, and a three-dimensional visual effect is generated by cerebral nerves. Coherent three-dimensional pictures are revealed, so that the audience can see a movie with three-dimensional visual images from the screen.

The polarizing projection technology is relatively common in three-dimensional cinemas, and the polarized eyeglasses have been used when three-dimensional movies were played in early times. However, the eyeglasses used at that time should be called as linearly polarized eyeglasses more exacly. The universal circular polarization technology is developed based on linear polarization technology, both technologies having substantially consistent principles. However, the circular polarization technology makes significant progress on displaying effect compared with the linear polarization.

When the linearly polarized eyeglasses are used for watching the three-dimensional movie, the eyeglasses should be kept in a horizontal position all through the time. In this way, the images with light in the horizontal polarizing direction are seen through a horizontal polarized lens, whereas images with light in the vertical polarizing direction are seen through a vertical polarized lens. If the eyeglasses are slightly deflected, a part of the images with light in the horizontal polarizing direction would be seen through the vertical polarized lens, and a part of the images with light in the vertical polarizing direction would be seen through the horizontal polarized lens. Therefore, the left and right eyes would see obvious ghosts. The polarizing direction of circularly polarized light rotates regularly, and the circularly polarized light may propagate with left-handed rotation or right-handed rotaion, wherein the interference between the left-handed light and the right-handed light is very weak. Furthermore, the propagating characteristic and the blocking characteristic of the circularly polarized light are substantially not affected by the rotating angle. When the three-dimensional movie in the polarizing form is displayed, one of the polarized lenses worn by the audience is a polarizer for left-handed polarized light, the other one is a polarizer for right-handed polarized light, which is to say, the left and right eyes of the audience see different pictures brought by the left-handed polarized light and the right-handed polarized light respectively, and thus third dimension is generated through human visual system.

However, in the prior art, no matter for the linearly polarized eyeglasses or the later developed three-dimensional eyeglasses receiving the circularly polarized light, the light finally entering human eyes through the three-dimensional eyeglasses is linearly polarized light.

The relationship between polarized light and visual fatigue of human eyes receiving the polarized light is disclosed in the document Evaluation of the Influence of Polarization Characteristics of Liquid Crystal Television on Visual Fatigue with Blink Rate.

In this document, the degrees of influence of linearly polarized light and circularly polarized light emitted by a liquid crystal television on the visual fatigue are compared. 64 cases of normal persons are randomly divided into two groups with 32 cases each group to see a feature movie played by a liquid crystal television of which the emergent light is the linearly polarized light or the circularly polarized light for 125 min respectively. The blink rates before and after seeing the feature movie and in the process of seeing the feature movie are recorded using electro-oculograms (EOG), and the variation characteristics of the blink rates are analyzed and compared. As a result, the blink rate after the linearly polarized light group sees the feature movie is higher than that before seeing, and the difference has statistical significance (P<0.01). The difference between the blink rates before and after the circularly polarized light group sees the feature movie does not have the statistical significance (P>0.05). It is concluded from the document that during long time watching, the visual fatigue is more easily caused with the liquid crystal television emitting linearly polarized light compared with the liquid crystal television emitting circularly polarized light.

It is thus clearly evident that in the prior art, when users see three-dimensional images through the three-dimensional eyeglasses, the light entering human eyes through the three-dimensional eyeglasses is the linearly polarized light, which easily leads to the visual fatigue of human eyes and damages the health of the eyes.

A ¼ wave plate is a crystal sheet for generating and checking circularly polarized light or elliptically polarized light. Suppose that a parallel beam is in normal incidence, the beam is transmitted straight out in the wave plate. The propagation speeds of two characteristic vibrations Eₒ(t) and Eₑ(t) on the transverse plane are vₒ and vₑ. Although passing through the plate of the same thickness, the optical paths Lₒ and Lₑ are not equal. In other words, through the wave plate, an additional phase difference is generated between Eₒ(t) and Eₑ(t).

FIG. 1 shows three-dimensional eyeglasses 10 in the prior art. The eyeglasses 10 include a polarizer 2 and a wave plate 1 on one side of the polarizer 2. The wave plate 1 is a quarter-wavelength wave plate and includes a left lens 1b and a right lens 1a corresponding to the left eye and the right eye of a user respectively, wherein the optical axis of the left lens 1b is vertical to that of the right lens 1a. The angles formed between the direction of the transmission axis of the polarizer 2 and those of the optical axes of the left lens 1b and the right lens 1a are both 45 degrees. The eyeglasses 10 will be improved in the present disclosure.

### SUMMARY OF THE INVENTION

In the prior art, when users see three-dimensional images through three-dimensional eyeglasses, the light entering human eyes through the three-dimensional eyeglasses is linearly polarized light, which easily leads to the visual fatigue of human eyes and damages the health of the eyes. If the three-dimensional eyeglasses in the prior art can be improved to transmit circularly polarized light which comforts human eyes, a considerable progress would be achieved compared with the technical solutions in the prior art.

The present disclosure proposes a type of three-dimensional eyeglasses.

The three-dimensional eyeglasses according to the present disclosure include a polarizer and a first wave plate on one side of the polarizer, the first wave plate is a quarter-wavelength wave plate and includes a first left lens and a first right lens corresponding to the left eye and the right eye of a user respectively, the optical axis of the first left lens is vertical to that of the first right lens, and the angles formed between the direction of the transmission axis of the polarizer and those of the optical axes of the first left lens and the first right lens are both 45 degrees, wherein, a second wave plate is arranged on the side of the polarizer away from the first wave plate, the light from a screen passes through the first wave plate, the polarizer and the second wave plate and is then emitted, and the second wave plate is arranged in such a manner that the light emitted after passing through the three-dimensional eyeglasses is circularly polarized light.

In such a manner, the light entering human eyes after passing through the three-dimensional eyeglasses is circularly polarized light, instead of the linearly polarized light in the prior art. This enables the human eyes to feel more comfortable and is less prone to cause fatigue.

Preferably, the second wave plate is a quarter-wavelength wave plate. The quarter-wavelength wave plate can convert the linearly polarized light passing through the polarizer into the circularly polarized light.

Preferably, the second wave plate includes a second left lens and a second right lens corresponding to the left eye and the right eye of the user respectively. The circularly polarized light transmitted through the second left lens and the second right lens corresponds to displayed images to be received by the left eye and the right eye respectively.

Preferably, the optical axes of the second left lens and the second right lens are vertical to each other. Thus, the rotating directions of the circularly polarized light transmitted through the second left lens and the second right lens are opposite to each other, and correspond to the displayed images to be received by the left eye and the right eye respectively.

Preferably, the angles formed between the direction of the transmission axis of the polarizer and those of the optical axes of the second left lens and the second right lens are both 45 degrees. Thus, the light entering the left and right eyes may be equally distributed, and the polarization states of the light on the two sides are in mirror symmetry.

Preferably, the optical axes of the first left lens and the second left lens are in the same direction, and/or the optical axes of the first right lens and the second right lens are in the same direction. In such a manner, materials can be conveniently cut and arranged during production and manufacturing process.

Preferably, the transmission axis of the polarizer is 90 degrees, with the angle of the horizontal plane set as 0 degree, the clockwise angle being positive and the anticlockwise angle being negative.

Preferably, the optical axis direction of the second left lens is negative 45 degrees, and the optical axis direction of the second right lens is positive 45 degrees.

Preferably, the optical axis direction of the first left lens is negative 45 degrees, and the optical axis direction of the first right lens is positive 45 degrees.

Preferably, the transmission axis of the polarizer is 0 degree, with the angle of the horizontal plane set as 0 degree, the clockwise angle being positive and the anticlockwise angle being negative.

Preferably, the optical axis direction of the second left lens is positive 45 degrees, and the optical axis direction of the second right lens is negative 45 degrees.

Preferably, the optical axis direction of the first left lens is positive 45 degrees, and the optical axis direction of the first right lens is negative 45 degrees.

According to the three-dimensional eyeglasses of the present disclosure, through the quarter-wavelength wave plates, the light entering the human eyes after passing through the three-dimensional eyeglasses becomes the circularly polarized light, which can well meet the requirements of the human eyes. This effectively prevents the visual fatigue of the user and prevents the eyes from being hurt after watching the three-dimensional images for a long term.

In the three-dimensional eyeglasses according to the present disclosure, the circularly polarized light emitted from the screen first passes through the first left lens and the first right lens of the first wave plate to be respectively converted into linearly polarized light of which the polarizing directions are vertical to each other. The linearly polarized light passes through the polarizer to form linearly polarized light of which the polarizing direction is the same with the direction of the transmission axis of the polarizer, and then the linearly polarized light passes through the second left lens and the second right lens of the second wave plate to be respectively converted into circularly polarized light of which the rotating directions are opposite to each other before entering the human eyes. The circularly polarized light with opposite rotating directions after passing through the second left lens and the second right lens corresponds to the displayed images to be watched by the left eye and the right eye respectively.

The above-mentioned technical features may be combined in various appropriate manners or substituted by equivalent technical features, as long as the objective of the present disclosure can be fulfilled.

### BRIEF DESCRIPTION OF THE DRAWINGS

The present disclosure will be described in more detail below based on merely nonfinite examples with reference to the accompanying drawings. Wherein:

FIG. 1 shows three-dimensional eyeglasses in the prior art;

FIG. 2 shows three-dimensional eyeglasses according to the present disclosure.

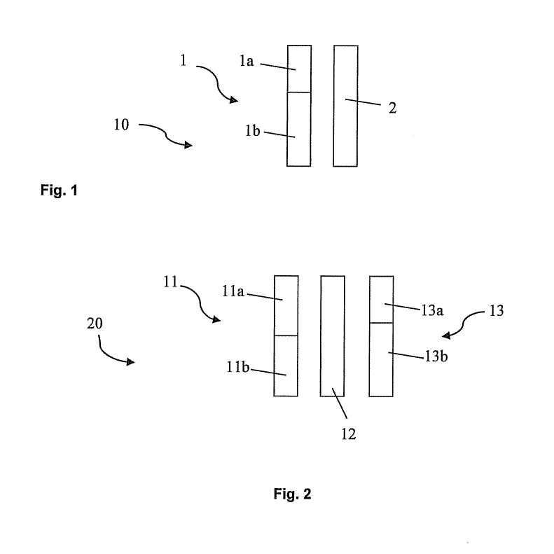

In the drawings, the same components are indicated by the same reference signs. The accompanying drawings are not drawn in an actual scale.

### DETAILED DESCRIPTION OF THE EMBODIMENTS

The present disclosure will be introduced in detail below with reference to the accompanying drawings.

FIG. 2 shows three-dimensional eyeglasses 20 according to the present disclosure. The eyeglasses 20 include a polarizer 12 and a first wave plate 11 on one side of the polarizer 12. The first wave plate 11 may be a quarter-wavelength wave plate, and includes a first left lens 11b and a first right lens 11a corresponding to the left eye and the right eye of a user respectively. The optical axis of the first left lens 11b is vertical to that of the first right lens 11a, and the angles formed between the transmission axis orientation of the polarizer 12 and the optical axis orientations of the first left lens 11b and the first right lens 11a are both 45 degrees.

A second wave plate 13 is arranged on the side of the polarizer 12 away from the first wave plate 11. The light emitted from a screen successively passes through the first wave plate 11, the polarizer 12 and the second wave plate 13, and then emitted. The second wave plate 13 is arranged in such a manner that the light emitted after passing through the three-dimensional eyeglasses 20 is circularly polarized light.

With reference to FIG. 2, the second wave plate 13 is a quarter-wavelength wave plate. The second wave plate 13 includes a second left lens 13b and a second right lens 13a corresponding to the left eye and the right eye of the user respectively. The optical axes of the second left lens 13b and the second right lens 13a are vertical to each other. The angles formed between the transmission axis orientation of the polarizer 12 and the optical axis orientations of the second left lens 13b and the second right lens 13a are both 45 degrees.

The optical axes of the first left lens 11b and the second left lens 13b are in the same direction, and/or the optical axes directions of the first right lens 11a and the second right lens 13a are in the same direction.

In an example, the transmission axis of the polarizer 12 is 90 degree, when the angle of the horizontal plane is set as 0 degree with the clockwise angle being positive and the anticlockwise angle being negative. In this case, the optical axis direction of the first left lens 11b is negative 45 degrees, and the optical axis direction of the first right lens 11a is positive 45 degrees. The optical axis direction of the second left lens 13b is negative 45 degrees, and the optical axis direction of the second right lens 13a is positive 45 degrees.

In another example, the transmission axis of the polarizer 12 is 0 degree, when the angle of the horizontal plane is set as 0 degree with the clockwise angle being positive and the anticlockwise angle being negative. In this case, the optical axis direction of the first left lens 11b is positive 45 degrees, and the optical axis direction of the first right lens 11a is negative 45 degrees. The optical axis direction of the second left lens 13b is positive 45 degrees, and the optical axis direction of the second right lens 13a is negative 45 degrees.

In the three-dimensional eyeglasses according to the present disclosure, the circularly polarized light emitted from the screen first passes through the first left lens 11b and the first right lens 11a of the first wave plate 11 to be respectively converted into linearly polarized light of which the polarizing directions are vertical to each other respectively. The linearly polarized light passes through the polarizer 12 to form linearly polarized light of which the polarizing direction is the same with the direction of the transmission axis of the polarizer 12. The linearly polarized light passes through the second left lens 13b and the second right lens 13a of the second wave plate 13 to be respectively converted into circularly polarized light of which the rotating directions are opposite before entering the human eyes.

According to research results, the linearly polarized light easily leads to the visual fatigue of human eyes and damages the health of the eyes. By contrast, the circularly polarized light enables the human eyes to feel more comfortable, and is less prone to cause visual fatigue. Therefore, the three-dimensional eyeglasses according to the present disclosure bring a significant progress compared with the prior art.

Although the present disclosure has been described with reference to the preferred examples, various modifications could be made to the present disclosure without departing from the scope of the present disclosure and components in the present disclosure could be substituted by equivalents. The present disclosure is not limited to the specific examples disclosed in the description, but includes all technical solutions falling into the scope of the claims.

1. Three-dimensional eyeglasses, including a polarizer and a first wave plate on one side of the polarizer, the first wave plate being a quarter-wavelength wave plate and including a first left lens and a first right lens corresponding to the left eye and the right eye of a user respectively, wherein the optical axis of the first left lens is vertical to that of the first right lens, and the angles formed between the direction of the transmission axis of the polarizer and those of the optical axes of the first left lens and the first right lens respectively are both 45 degrees, and wherein a second wave plate is arranged on the side of the polarizer away from the first wave plate, whereby the light from a screen passes through the first wave plate, the polarizer and the second wave plate, and then emitted, and the second wave plate is arranged in such a manner that the light emitted after passing through the three-dimensional eyeglasses is circularly polarized light.

2. The three-dimensional eyeglasses according to claim 1, wherein the second wave plate is a quarter-wavelength wave plate.

3. The three-dimensional eyeglasses according to claim 2, wherein the second wave plate includes a second left lens and a second right lens corresponding to the left eye and the right eye of the user respectively.

4. The three-dimensional eyeglasses according to claim 3, wherein the optical axes of the second left lens and the second right lens are vertical to each other.

5. The three-dimensional eyeglasses according to claim 4, wherein the angles formed between the direction of the transmission axis of the polarizer and those of the optical axes of the second left lens and the second right lens respectively are both 45 degrees.

6. The three-dimensional eyeglasses according to claim 4, wherein the optical axes of the first left lens and the second left lens are in the same direction, and/or the optical axes of the first right lens and the second right lens are in the same direction.

7. The three-dimensional eyeglasses according to claim 4, wherein the transmission axis of the polarizer is 90 degrees, when the angle of the horizontal plane is set as 0 degree with the clockwise angle being positive and the anticlockwise angle being negative.

8. The three-dimensional eyeglasses according to claim 7, wherein the optical axis direction of the second left lens is negative 45 degrees, and the optical axis direction of the second right lens is positive 45 degrees.

9. The three-dimensional eyeglasses according to claim 7, wherein the optical axis direction of the first left lens is negative 45 degrees, and the optical axis direction of the first right lens is positive 45 degrees.

10. The three-dimensional eyeglasses according to claim 8, wherein the optical axis direction of the first left lens is negative 45 degrees, and the optical axis direction of the first right lens is positive 45 degrees.

11. The three-dimensional eyeglasses according to claim 4, wherein the transmission axis of the polarizer is 0 degree, the optical axis direction of the second left lens is positive 45 degrees and the optical axis direction of the second right lens is negative 45 degrees, when the angle of the horizontal plane is set as 0 degree with the clockwise angle being positive and the anticlockwise angle being negative.
